(19) United States
(12) Patent Application Publication
(10) Pub. No.: US 2026/0322412 A1
(43) Pub. Date: Oct. 15, 2026

(54) RADIO FREQUENCY MODULE

(71) Applicant: Murata Manufacturing Co., Ltd., Nagaokakyo-shi (JP)

(72) Inventor: Dai NAKAGAWA, Nagaokakyo-shi (JP)

(73) Assignee: Murata Manufacturing Co., Ltd., Nagaokakyo-shi (JP)

(21) Appl. No.: 19/645,353

(22) Filed: Apr. 13, 2026

(30) Foreign Application Priority Data
Apr. 14, 2025 (JP) 2025-066320

(51) Int. Cl. H04B 1/04

(52) U.S. Cl. CPC H04B 1/04; H04B 2001/0408

(57) ABSTRACT

A radio frequency module includes: a control terminal for receiving a digital control signal; a control circuit connected to the control terminal; first and second power amplifiers connected to the control circuit; a first filter having a pass band including a transmission band of a band A; a second filter having a pass band including a transmission band of a band B; a switch circuit included in a semiconductor component and connected between the first power amplifier and the first filter; and a switch circuit included in a semiconductor component and connected between the second power amplifier and the second filter. The control circuit includes a digital processor configured to process the digital control signal. The switch circuit is connected to an output end of the digital processor. The switch circuit is connected to the control terminal without the digital processor interposed therebetween.

### CROSS-REFERENCE TO RELATED APPLICATION

The present application claims priority to Japanese Patent Application No. 2025-066320, filed on Apr. 14, 2025, the entire contents of which are incorporated herein by reference.

### BACKGROUND

### 1. Field

The present disclosure relates to a radio frequency module.

### 2. Description of the Related Art

Japanese Unexamined Patent Application Publication No. 2014-096627 discloses a front-end device that includes an upper device controlled based on a serial signal and a lower device controlled based on a parallel signal converted from the serial signal.

### SUMMARY

A radio frequency module according to an aspect of the present disclosure includes: a first control terminal for receiving a first digital control signal; a control circuit connected to the first control terminal; a first power amplifier and a second power amplifier, each connected to the control circuit; a first filter having a pass band including a transmission band of a first band; a second filter having a pass band including a transmission band of a second band; a first switch circuit included in a first semiconductor component and connected between the first power amplifier and the first filter; and a second switch circuit included in a second semiconductor component and connected between the second power amplifier and the second filter. The control circuit includes a first digital processor configured to process the first digital control signal. One of the first switch circuit and the second switch circuit is connected to an output end of the first digital processor. The other of the first switch circuit and the second switch circuit is connected to the first control terminal without the first digital processor interposed therebetween.

### BRIEF DESCRIPTION OF THE DRAWINGS

FIG. 1 is a configuration diagram of a communication device according to Embodiment 1;

FIG. 2 is a circuit configuration diagram of a radio frequency module according to Embodiment 1;

FIG. 3 is a plan view of the radio frequency module according to Embodiment 1;

FIG. 4 is a plan view of the radio frequency module according to Embodiment 1;

FIG. 5 is a diagram showing an example of a leakage path of a transmission signal in the radio frequency module according to Embodiment 1;

FIG. 6 is a circuit configuration diagram of a radio frequency module according to Embodiment 2;

FIG. 7 is a layout diagram of a semiconductor component and a control line according to Embodiment 2;

FIG. 8 is a circuit configuration diagram of a radio frequency module according to Embodiment 3;

FIG. 9 is a circuit configuration diagram of a radio frequency module according to Embodiment 4;

FIG. 10 is a circuit configuration diagram of a radio frequency module according to Embodiment 5;

FIG. 11 is a diagram showing an example of a leakage path of a transmission signal in the radio frequency module according to Embodiment 5; and

FIG. 12 is a circuit configuration diagram of a radio frequency module according to Embodiment 6.

### DETAILED DESCRIPTION

The inventor has recognized that, with the above-mentioned technology of the related art, leakage of a radio frequency signal through a transmission line of a control signal can sometimes cause deterioration in quality of a transmission signal and/or a reception signal.

Therefore, the present disclosure is directed to providing a radio frequency module capable of suppressing deterioration in quality of a transmission signal and/or a reception signal.

Embodiments of the present disclosure will be described in detail below with reference to the drawings. Note that the embodiments described below are all intended to represent comprehensive or specific examples. Numerical values, shapes, materials, constituent elements, arrangement and connection forms of the constituent elements, and so forth described in the following embodiments are examples and are not intended to limit the present disclosure.

It is noted that each drawing is a schematic diagram in which emphasis, omissions, or ratios are adjusted as necessary to illustrate the present disclosure. The drawings are not necessarily strict illustrations and may differ from the actual shape, positional relationship, and ratios. In each drawing, substantially identical configurations are denoted by the same reference numerals, and redundant description may be omitted or simplified.

In the following diagrams, the x-axis and the y-axis are axes orthogonal to each other on a plane parallel to a main surface of a module substrate. Moreover, the z-axis is an axis perpendicular to the main surface of the module substrate. The positive direction of the z-axis indicates an upward direction, and the negative direction thereof indicates a downward direction.

In the following description, the term “connected” includes not only a case where a direct connection is established by a connection terminal and/or a wiring conductor but also a case where an electrical connection is established using other circuit elements. The expression “C is connected between A and B” means that one end of C is connected to A and the other end of C is connected to B. This means that C is arranged in series in the path connecting A and B. The “path connecting A and B” means a path composed of conductors that electrically connect A to B.

The term “filter pass band” refers to a portion of a frequency spectrum transmitted by a filter, and is defined as a frequency band between two frequencies that are 3 dB above the minimum value of power insertion loss.

The term “transmission band” refers to a frequency band used for transmission in a communication device. The term “reception band” refers to a frequency band used for reception in the communication device. For example, in a frequency division duplex (FDD) band, different frequency bands (an uplink band and a downlink band) are used as the transmission band and the reception band. For example, in a time division duplex (TDD) band, the same frequency band is used for the transmission band and the reception band.

The term “harmonic wave band of a given band” refers to a band extending from n times the low frequency end of the given band to n times the radio frequency end of the given band. Here, n is a natural number greater than or equal to 2. For example, the second harmonic wave band of the given band is the band extending from twice the low frequency end of the given band to twice the radio frequency end of the given band. The third harmonic wave band of the given band is the band extending from three times the low frequency end of the given band to three times the radio frequency end of the given band. Note that if no order is specified, the “harmonic wave band” refers to all harmonic wave bands of all orders.

The term “band combination capable of simultaneous communication” refers to a combination of a plurality of frequency bands capable of simultaneous transmission, simultaneous reception, or simultaneous transmission and reception, and is predefined by a standardizing body or the like (for example, the 3rd Generation Partnership Project (3GPP) (registered trademark) and the Institute of Electrical and Electronics Engineers (IEEE)). Examples of “simultaneous communication” include Carrier Aggregation (CA), E-UTRAN New Radio Dual Connectivity (EN-DC), New Radio Dual Connectivity (NR-DC), and New Radio E-UTRAN Dual Connectivity (NE-DC).

The term “terminal” means the point where a conductor within an element terminates. Note that if the impedance of a conductor between elements is sufficiently low, a terminal can be construed as any point on the conductor between the elements or the entire conductor, rather than just a single point.

The expression “a component is disposed in or on a substrate” includes the component being disposed on a main surface of the substrate and the component being disposed in the substrate. Moreover, the expression “a component is disposed on the main surface of the substrate” includes the component being disposed in contact with the main surface of the substrate, and also includes the component being disposed above the main surface without being in contact with the main surface (for example, the component being stacked on another component disposed in contact with the main surface). Furthermore, the expression “a component is disposed on the main surface of the substrate” includes the component being disposed in a recess formed in the main surface. The expression “a component is disposed in the substrate” includes the component being encapsulated within the substrate. The expression “a component is disposed in the substrate” also includes the entire component being disposed between both main surfaces of the substrate but having part left uncovered by the substrate, and includes only part of the component being disposed in the substrate.

The expression “A is disposed between B and C” means that at least one of a plurality of line segments connecting any point within B and any point within C passes through A. The expression “A is disposed closer to C than B” means that the distance between A and C is shorter than the distance between B and C. Here, the “distance between A (B) and C” refers to the length of the shortest line segment (that is, the shortest distance) among a plurality of line segments connecting any point on the surface of A (B) and any point on the surface of C.

The term “plan view of the module substrate” refers to viewing an object in an orthographic projection onto the xy-plane in a negative direction of the z-axis. Moreover, the expression “A overlaps with B in plan view of the module substrate” means that the region of A orthographically projected onto the xy-plane overlaps with the region of B orthographically projected onto the xy-plane.

Furthermore, terms indicating the relationship between elements, such as “parallel” and “perpendicular”, terms indicating the shape of elements, such as “rectangle”, and numerical ranges do not necessarily denote the exact meanings but denote substantially the same meanings involving, for example, several percent differences.

### Embodiment 1

Embodiment 1 will be described below.

### 1.1. Configuration of Communication Device 5

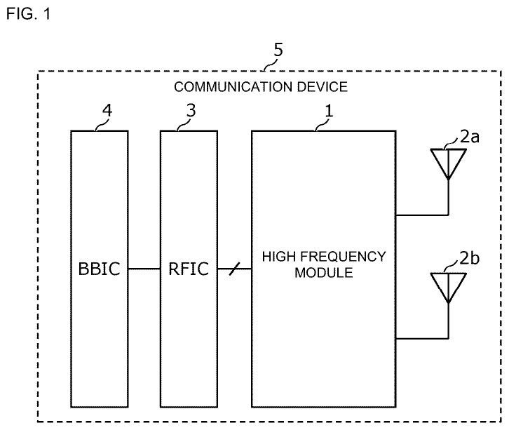

First, a configuration of a communication device 5 according to this embodiment will be described with reference to FIG. 1. FIG. 1 is a configuration diagram of the communication device 5 according to this embodiment.

Note that FIG. 1 shows an exemplary configuration, and the communication device 5 may be implemented using any of a wide variety of circuit implementations and circuit technologies. Therefore, the following description of the communication device 5 is not to be construed as limiting.

The communication device 5 can be used to provide wireless connection. For example, the communication device 5 can be implemented in a UE in a cellular network (also known as a mobile network), such as a mobile phone, smartphone, tablet computer, or wearable device. In another example, the communication device 5 can be implemented to provide wireless connection to an Internet of Things (IoT) sensor device, a medical/healthcare device, a car, an unmanned aerial vehicle (UAV) (so-called a drone), or an automated guided vehicle (AGV). In yet another example, the communication device 5 can be implemented to provide wireless connection at wireless access points or wireless hotspots.

The communication device 5 includes a radio frequency module 1, antennas 2a and 2b, a radio frequency integrated circuit (RFIC) 3, and a baseband integrated circuit (BBIC) 4.

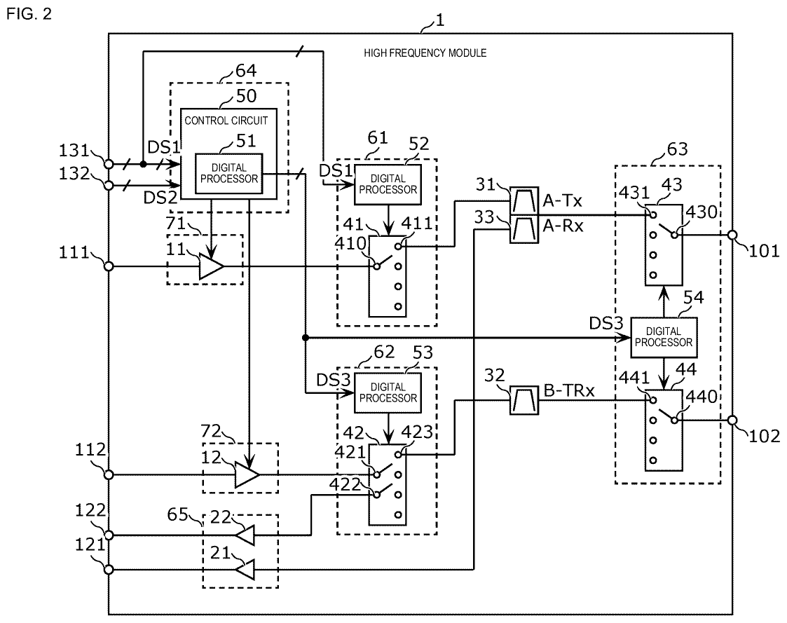

The radio frequency module 1 can transmit radio frequency signals between the antennas 2a and 2b and the RFIC 3. A circuit configuration of the radio frequency module 1 will be described later with reference to FIG. 2.

The antennas 2a and 2b are connected to the radio frequency module 1. The antennas 2a and 2b can receive radio frequency signals from the radio frequency module 1 and transmit the received signals to the outside of the communication device 5. The antennas 2a and 2b can also receive radio frequency signals from the outside of the communication device 5 and supply the received signals to the radio frequency module 1. Note that one or both of the antennas 2a and 2b do not need to be included in the communication device 5. The communication device 5 may also include one or more antennas in addition to the antennas 2a and 2b.

The RFIC 3 is an example of a signal processing circuit for processing radio frequency signals. Specifically, the RFIC 3 can process a transmission signal inputted from the BBIC 4 by upconversion or the like, and output the radio frequency transmission signal generated through this signal processing to the radio frequency module 1. The RFIC 3 can also process a radio frequency reception signal inputted through the radio frequency module 1 by downconversion or the like, and output the reception signal generated through this signal processing to the BBIC 4. The RFIC 3 may also have a control unit that controls switches and amplifiers of the radio frequency module 1. Note that some or all of the functions of the control unit of the RFIC 3 may be included outside the RFIC 3, for example, in the BBIC 4 or the radio frequency module 1.

The BBIC 4 is a baseband signal processing circuit for processing signals using a frequency band lower than the radio frequency signal transmitted by the radio frequency module 1. Examples of the signals processed by the BBIC 4 include image signals for image display and/or audio signals for calls via a speaker.

### 1.2. Circuit Configuration of Radio Frequency Module 1

Next, the circuit configuration of the radio frequency module 1 according to this embodiment will be described with reference to FIG. 2. FIG. 2 is a circuit configuration diagram of the radio frequency module 1 according to this embodiment.

Note that FIG. 2 shows an exemplary circuit configuration, and the radio frequency module 1 can be implemented using any of a wide variety of circuit implementations and circuit technologies. Therefore, the following description of the radio frequency module 1 is not to be construed as limiting.

The radio frequency module 1 includes power amplifiers 11 and 12, low-noise amplifiers 21 and 22, filters 31, 32, and 33, switch circuits 41, 42, 43, and 44, a control circuit 50, digital processors 51, 52, 53, and 54, antenna connection terminals 101 and 102, radio frequency input terminals 111 and 112, radio frequency output terminals 121 and 122, and control terminals 131 and 132.

The antenna connection terminals 101 and 102 are an example of a first antenna connection terminal and an example of a second antenna connection terminal, respectively, and are external connection terminals of the radio frequency module 1. The antenna connection terminals 101 and 102 are terminals for supplying radio frequency signals to the antennas 2a and 2b, and for receiving radio frequency signals from the antennas 2a and 2b. The antenna connection terminal 101 is connected to the antenna 2a outside the radio frequency module 1, and is connected to the switch circuit 43 inside the radio frequency module 1. The antenna connection terminal 102 is connected to the antenna 2b outside the radio frequency module 1, and is connected to the switch circuit 44 inside the radio frequency module 1.

The radio frequency input terminals 111 and 112 are external connection terminals of the radio frequency module 1, and are terminals for receiving radio frequency signals from the RFIC 3. The radio frequency input terminals 111 and 112 are connected to the RFIC 3 outside the radio frequency module 1, and are connected to the power amplifiers 11 and 12, respectively, inside the radio frequency module 1.

The radio frequency output terminals 121 and 122 are external connection terminals of the radio frequency module 1, and are terminals for supplying radio frequency signals to the RFIC 3. The radio frequency output terminals 121 and 122 are connected to the RFIC 3 outside the radio frequency module 1, and are connected to the low-noise amplifiers 21 and 22, respectively, inside the radio frequency module 1.

The control terminals 131 and 132 are an example of a first control terminal and an example of a second control terminal, respectively, and are external connection terminals of the radio frequency module 1. The control terminals 131 and 132 are terminals for receiving digital control signals DS1 and DS2, respectively, from the RFIC 3. The control terminals 131 and 132 are connected to the RFIC 3 outside the radio frequency module 1, and are connected to the control circuit 50 inside the radio frequency module 1.

The power amplifier 11 is an example of a first power amplifier, and is included in a semiconductor component 71. The power amplifier 11 is connected between the radio frequency input terminal 111 and the filter 31. Specifically, the power amplifier 11 has an input end connected to the radio frequency input terminal 111. The power amplifier 11 has an output end switchably connected to the filter 31 through the switch circuit 41. The power amplifier 11 can amplify a transmission signal of a band A, using power supplied from a power supply (not shown). As used herein, the term “downstream switching circuitry” refers to switching circuitry located further along a transmission or signal path than a first switching circuitry.

The power amplifier 12 is an example of a second power amplifier, and is included in a semiconductor component 72. The power amplifier 12 is connected between the radio frequency input terminal 112 and the filter 32. Specifically, the power amplifier 12 has an input end connected to the radio frequency input terminal 112. The power amplifier 12 has an output end switchably connected to the filter 32 through the switch circuit 42. The power amplifier 12 can amplify a transmission signal of a band B, using power supplied from a power supply (not shown).

The power amplifiers 11 and 12 may each be composed of a plurality of amplifiers. For example, the power amplifiers 11 and 12 may each be a multistage amplifier including a plurality of amplifiers connected in series. Alternatively, for example, the power amplifiers 11 and 12 may each be a differential or balanced power amplifier or a Doherty amplifier, including a plurality of amplifiers connected in parallel.

The low-noise amplifier 21 is included in a semiconductor component 65 and connected between the filter 33 and the radio frequency output terminal 121. Specifically, the low-noise amplifier 21 has an input end connected to the filter 33. The low-noise amplifier 21 has an output end connected to the radio frequency output terminal 121. The low-noise amplifier 21 can amplify a reception signal of the band A, using power supplied from a power supply (not shown). Alternatively, the low-noise amplifier 21 may be connected between the radio frequency module 1 and the RFIC 3, or may be included in the RFIC 3.

The low-noise amplifier 22 is included in the semiconductor component 65 and connected between the filter 32 and the radio frequency output terminal 122. Specifically, the low-noise amplifier 22 has an input end switchably connected to the filter 32 through the switch circuit 42. The low-noise amplifier 22 has an output end connected to the radio frequency output terminal 122. The low-noise amplifier 22 can amplify a reception signal of the band B, using power supplied from a power supply. Alternatively, the low-noise amplifier 22 may be connected between the radio frequency module 1 and the RFIC 3, or may be included in the RFIC 3.

The filter 31 is an example of a first filter, and is a band pass filter having a pass band that includes a transmission band (A-Tx) of the band A. The filter 31 is connected between the power amplifier 11 and the antenna connection terminal 101. Specifically, the filter 31 has one end switchably connected to the output end of the power amplifier 11 through the switch circuit 41. The filter 31 has the other end switchably connected to the antenna connection terminal 101 through the switch circuit 43.

The filter 32 is an example of a second filter, and is a band pass filter having a pass band that includes transmission and reception bands (B-TRx) of the band B. The filter 32 is connected between the antenna connection terminal 102 and both the power amplifier 12 and the low-noise amplifier 22. Specifically, the filter 32 has one end switchably connected to the output end of the power amplifier 12 and the input end of the low-noise amplifier 22 through the switch circuit 42. The filter 32 has the other end switchably connected to the antenna connection terminal 102 through the switch circuit 44.

The filter 33 is a band pass filter having a pass band that includes a reception band (A-Rx) of the band A. The filter 33 is connected between the low-noise amplifier 21 and the antenna connection terminal 101. Specifically, the filter 33 has one end connected to the input end of the low-noise amplifier 21. The filter 33 has the other end switchably connected to the antenna connection terminal 101 through the switch circuit 43.

Note that the filters 31 to 33 are not limited to the band pass filters. Some or all of the filters 31 to 33 may be band elimination filters, high pass filters, low pass filters, or any combination thereof.

The bands A and B are frequency bands for a communication system built using a radio access technology (RAT). The bands A and B are predefined by a standardizing body or the like (for example, 3GPP (registered trademark) and IEEE). Examples of the communication system include a fifth generation new radio (5GNR) system, a fourth generation long term evolution (4GLTE) system, a second generation global system for mobile communications (2GGSM) system, a wireless local area network (WLAN) system, and the like.

The band A is an example of a first band, and is a frequency band included in a first band group. In this embodiment, the band A is an FDD band, but may also be a TDD band or supplementary uplink (SUL) band. The band A can be Band 8, Band 26, or Band 28 for LTE, or n8, n26, or n28 for 5GNR. Note that the band A is not limited to these bands.

The band B is an example of a second band, and is a frequency band included in a second band group or a third band group. In this embodiment, the band B is a TDD band, but may also be an FDD band or SUL band. The band B can be Band 40 or Band 41 for LTE, or n40 or n41 for 5GNR. The band B may also be Band 1 or Band 3, or n1 or n3 for 5GNR. Note that the band B is not limited to these bands.

The bands A and B may be a band combination capable of simultaneous communication. Furthermore, a harmonic wave band of the transmission band of the band A may at least partially overlap with the band B. Using such bands A and B achieves a significant effect of suppressing deterioration in quality of a transmission signal and/or a reception signal.

The band group refers to a frequency range that includes a plurality of frequency bands for a wireless communication system. The first band group is lower than the second band group and the third band group. For example, a low band group (617 to 960 MHz) is used as the first band group. A mid band group (1427 to 2200 MHz) is used as the second band group. A high band group (2300 to 2690 MHz) is used as the third band group.

Note that the combination of the first band group, the second band group, and the third band group is not limited to the combination of the low band group, the mid band group, and the high band group. For example, the combination of the first band group, the second band group, and the third band group may be any combination of three of the low band group, the mid band group, the high band group, and an ultra-high band group (3300 to 5000 MHz). Furthermore, the first band group, the second band group, and the third band group may be band groups outside a frequency range 1 (FR1) (600 MHz to 7.125 GHz). Some or all of the first band group, the second band group and the third band group may be band groups within a frequency range 2 (FR2) (24.25 GHz to 71 GHz) and a frequency range 3 (FR3) (7.125 GHz to 24.25 GHz), for example.

The switch circuit 41 is an example of a first switch circuit, and is a single-pole X-throw (SPXT) type switch circuit included in a semiconductor component 61. The switch circuit 41 is connected between the power amplifier 11 and the filter 31. Specifically, the switch circuit 41 includes a common terminal 410 connected to the output end of the power amplifier 11 and a selection terminal 411 connected to one end of the filter 31. The switch circuit 41 may also include one or more selection terminals connected to one or more other filters (not shown). The switch circuit 41 is also connected to the control terminal 131 through the digital processor 52, not through the digital processor 51.

In this connection state, the switch circuit 41 can switch between connection and disconnection between the power amplifier 11 and the filter 31 in accordance with a control signal generated by the digital processor 52 based on the digital control signal DS1.

The switch circuit 42 is an example of a second switch circuit, and is a double-pole X-throw (DPXT) type switch circuit included in a semiconductor component 62. The switch circuit 42 is connected between the filter 32 and both the power amplifier 12 and the low-noise amplifier 22. Specifically, the switch circuit 42 includes terminals 421, 422, and 423. The terminal 421 is an example of a first terminal, and is connected to the output end of the power amplifier 12. The terminal 422 is an example of a second terminal, and is connected to the input end of the low-noise amplifier 22. The terminal 423 is an example of a third terminal, and is connected to one end of the filter 32. The switch circuit 42 may also include one or more selection terminals connected to one or more other filters (not shown). The switch circuit 42 is also connected to the digital processor 51 through the digital processor 53.

In this connection state, the switch circuit 42 can switch the connection of the filter 32 between the power amplifier 12 and the low-noise amplifier 22 in accordance with a control signal generated by the digital processor 53 based on a digital control signal DS3.

The switch circuit 43 is an example of a third switch circuit, and is an SPXT-type switch circuit included in a semiconductor component 63. The switch circuit 43 is connected between the antenna connection terminal 101 and the filters 31 and 33. Specifically, the switch circuit 43 includes a common terminal 430 connected to the antenna connection terminal 101 and a selection terminal 431 connected to the other ends of the filters 31 and 33. The switch circuit 43 may further include one or more selection terminals connected to one or more other filters (not shown) for the first band group. The switch circuit 43 is also connected to the digital processor 51 through the digital processor 54.

In this connection state, the switch circuit 43 can switch between connection and disconnection between the antenna connection terminal 101 and the filters 31 and 33 in accordance with a control signal generated by the digital processor 54 based on the digital control signal DS3.

The switch circuit 44 is an example of a fourth switch circuit, and is an SPXT-type switch circuit included in the semiconductor component 63. The switch circuit 44 is connected between the antenna connection terminal 102 and the filter 32. Specifically, the switch circuit 44 includes a common terminal 440 connected to the antenna connection terminal 102 and a selection terminal 441 connected to the other end of the filter 32. The switch circuit 44 may further include one or more selection terminals connected to one or more other filters (not shown) for the second band group or the third band group. The switch circuit 44 is also connected to the digital processor 51 through the digital processor 54.

In this connection state, the switch circuit 44 can switch between connection and disconnection between the antenna connection terminal 102 and the filter 32 in accordance with a control signal generated by the digital processor 54 based on the digital control signal DS3.

The control circuit 50 is included in a semiconductor component 64 and connected to the control terminals 131 and 132. The control circuit 50 can control the power amplifiers 11 and 12 based on the digital control signals DS1 and DS2 supplied from the RFIC 3 through the control terminals 131 and 132. The control circuit 50 includes the digital processor 51.

The digital processor 51 is an example of a first digital processor, and is connected between the control terminals 131 and 132 and the digital processors 53 and 54. Specifically, first and second input ends of the digital processor 51 are connected to the control terminals 131 and 132, respectively. The digital processor 51 has an output end connected to the input ends of the digital processors 53 and 54. The digital processor 51 can process the digital control signals DS1 and DS2 supplied from the RFIC 3 through the control terminals 131 and 132. Specifically, the digital processor 51 can output the digital control signal DS3 by combining the digital control signals DS1 and DS2.

The digital processor 52 is an example of a second digital processor, and is included in the semiconductor component 61. The digital processor 52 is connected between the control terminal 131 and the switch circuit 41 without the digital processor 51 interposed therebetween. Specifically, the digital processor 52 has an input end connected to the control terminal 131 without the digital processor 51 interposed therebetween. The digital processor 52 has an output end connected to the switch circuit 41. The digital processor 52 can output a control signal for controlling the switch circuit 41 by processing the digital control signal DS1 supplied from the RFIC 3 through the control terminal 131.

The digital processor 53 is an example of a third digital processor, and is included in the semiconductor component 62. The digital processor 53 is connected between the digital processor 51 and the switch circuit 42. Specifically, the digital processor 53 has an input end connected to the output end of the digital processor 51. The digital processor 53 has an output end connected to the switch circuit 42. The digital processor 53 can output a control signal for controlling the switch circuit 42 by processing the digital control signal DS3 supplied from the digital processor 51.

The digital processor 54 is an example of a fourth digital processor, and is included in the semiconductor component 63. The digital processor 54 is connected between the digital processor 51 and the switch circuits 43 and 44. Specifically, the digital processor 54 has an input end connected to the output end of the digital processor 51. The digital processor 54 has first and second output ends connected to the switch circuits 43 and 44, respectively. The digital processor 54 can output a control signal for controlling the switch circuits 43 and 44 by processing the digital control signal DS3 supplied from the digital processor 51.

The digital control signal DS1 is an example of a first digital control signal, and is a control signal for the first band group and the second band group. The digital control signal DS2 is an example of a second digital control signal, and is a control signal for the third band group. The digital control signal DS3 is an example of a third digital control signal, and is a control signal for the first band group, the second band group, and the third band group. Source-synchronous serial data signals are used as the digital control signals DS1, DS2, and DS3. Alternatively, clock-embedded serial data signals may be used as the digital control signals DS1, DS2, and DS3.

### 1.3. Mounting Example of Radio Frequency Module 1

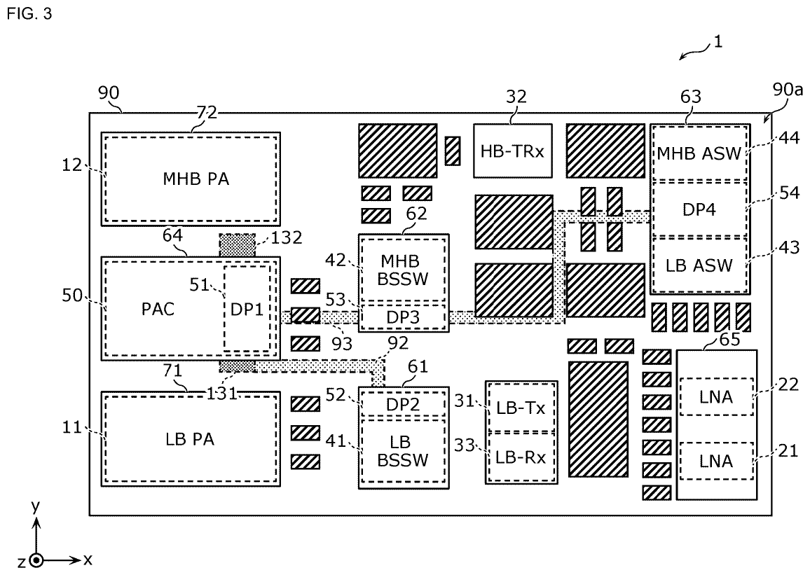

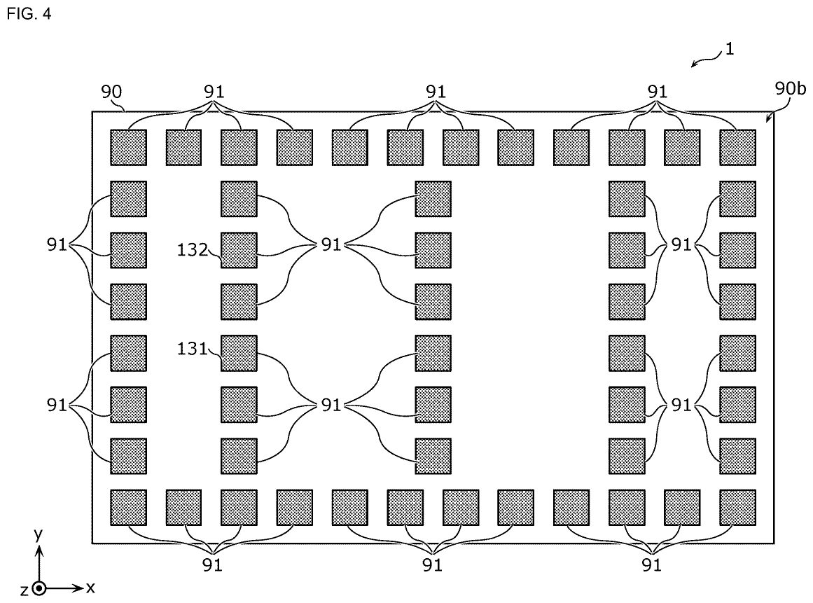

Next, a mounting example of the radio frequency module 1 having the circuit configuration described above will be described with reference to FIGS. 3 and 4. FIG. 3 is a plan view of the radio frequency module 1 according to this embodiment. FIG. 4 is a plan view of the radio frequency module 1 according to this embodiment, where the main surface 90b side of a module substrate 90 is seen through from the positive side of the z-axis.

In FIGS. 3 and 4, each component is labeled to facilitate understanding of positional relationships between the components. In FIG. 3, regions within the semiconductor component, part of wiring within the module substrate 90, and some of the external connection terminals on the main surface 90b are indicated by dashed lines.

Note that FIGS. 3 and 4 show an exemplary configuration, and the radio frequency module 1 can be implemented using any of a wide variety of circuit implementations and circuit technologies. Therefore, the following description of the radio frequency module 1 is not to be construed as limiting.

The module substrate 90 has main surfaces 90a and 90b facing each other. In addition to control lines 92 and 93, wiring and via electrodes (not shown) are formed in and/or on the module substrate 90.

The control lines 92 and 93 are transmission lines for the digital control signals DS1 and DS3, respectively. The control lines 92 and 93 can be, but are not limited to, pattern wiring, via conductors, bonding wires, or any combination thereof.

The module substrate 90 can be, but is not limited to, for example, a low temperature co-fired ceramic (LTCC) substrate or a high temperature co-fired ceramic (HTCC) substrate having a multilayer structure of a plurality of dielectric layers, a component-embedded substrate, a substrate having a redistribution layer (RDL), a printed circuit board or the like.

The filter 31 (LB-Tx), the filter 32 (HB-TRx), and the filter 33 (LB-Rx) are disposed on the main surface 90a of the module substrate 90. The filters 31 to 33 may be, but are not limited to, surface acoustic wave (SAW) filters, bulk acoustic wave (BAW) filters, LC filters, dielectric filters, or any combination thereof.

The semiconductor component 61 is an example of a first semiconductor component, and is disposed on the main surface 90a of the module substrate 90. The semiconductor component 61 includes the switch circuit 41 (LB BSSW) and the digital processor 52 (DP2). The semiconductor component 61 is electrically connected to the control terminal 131 disposed on the main surface 90b of the module substrate 90 through the control line 92 formed on and/or in the module substrate 90.

The semiconductor component 62 is an example of a second semiconductor component, and is disposed on the main surface 90a of the module substrate 90. The semiconductor component 62 includes the switch circuit 42 (MHB BSSW) and the digital processor 53 (DP3). The semiconductor component 62 is electrically connected to the semiconductor component 64 through the control line 93 formed on and/or in the module substrate 90.

The semiconductor component 63 is an example of a third semiconductor component, and is disposed on the main surface 90a of the module substrate 90. The semiconductor component 63 includes the switch circuit 43 (LB ASW), the switch circuit 44 (MHB ASW), and the digital processor 54 (DP4). In the semiconductor component 63, the digital processor 54 is disposed between the switch circuits 43 and 44. The semiconductor component 63 is electrically connected to the semiconductor component 64 through the control line 93 formed on and/or in the module substrate 90.

The semiconductor component 64 is disposed on the main surface 90a of the module substrate 90, and includes the control circuit 50 (PAC) including the digital processor 51 (DP1). The semiconductor component 64 is electrically connected to the control terminals 131 and 132 disposed on the main surface 90b of the module substrate 90 through via conductors (not shown) formed in the module substrate 90. The semiconductor component 64 is also electrically connected to the semiconductor components 62 and 63 through the control line 93 formed on and/or in the module substrate 90.

The semiconductor component 65 is a semiconductor integrated circuit including the low-noise amplifiers 21 and 22 (LNAs), and is disposed on the main surface 90a of the module substrate 90. If the low-noise amplifier 21 or 22 is connected to a plurality of filters, the semiconductor component 65 may include a switch circuit for switchably connecting the low-noise amplifier 21 or 22 to the plurality of filters.

A semiconductor material for the semiconductor components 61 to 65 can be, for example, silicon single crystal (Si), gallium nitride (GaN), or silicon carbide (SiC). In this case, the switch circuits 41 to 44 can be composed of field-effect transistors (FETs). Some or all of the low-noise amplifiers 21 and 22 can also be composed of FETs.

The semiconductor components 71 and 72 are semiconductor integrated circuits including the power amplifier 11 (LB PA) and the power amplifier 12 (MHB PA), respectively, and are disposed on the main surface 90a of the module substrate 90. A semiconductor material for the semiconductor components 71 and 72 can be, for example, silicon germanium (SiGe) or gallium arsenide (GaAs). In this case, some or all of the power amplifiers 11 and 12 can be composed of heterojunction bipolar transistors (HBTs). Note that the semiconductor material for the semiconductor components 71 and 72 can also be gallium nitride (GaN) or silicon carbide (SiC). In this case, some or all of the power amplifiers 11 and 12 may be composed of high electron mobility transistors (HEMTs) or metal-semiconductor field effect transistors (MESFETs). Note that the semiconductor material for the semiconductor components 71 and 72 can also be silicon single crystal (Si). In this case, some or all of the power amplifiers 11 and 12 may be composed of complementary metal oxide semiconductors (CMOSs), or may be manufactured using a silicon-on-insulator (SOI) process.

Note that the semiconductor components 71 and 72 may be integrated into a single semiconductor component. Alternatively, the semiconductor components 71 and 72 may each be divided into a plurality of semiconductor components.

A plurality of external connection terminals 91 are disposed on the main surface 90b of the module substrate 90, and include the antenna connection terminals 101 and 102, the radio frequency input terminals 111 and 112, the radio frequency output terminals 121 and 122, the control terminals 131 and 132, and a ground terminal. In FIGS. 3 and 4, only the control terminals 131 and 132 are distinguished from the other terminals. Outside the radio frequency module 1, some or all of the plurality of external connection terminals 91 are electrically connected to the input and output terminals and/or the ground terminal on a motherboard (not shown) disposed in the negative direction of the z-axis of the radio frequency module 1. Inside the radio frequency module 1, some or all of the plurality of external connection terminals 91 are electrically connected to the components in the module substrate 90.

While FIGS. 3 and 4 illustrate a single-sided mounting module having the circuit components disposed on only one side (main surface 90a) of the module substrate 90, the radio frequency module 1 according to this embodiment may also be a double-sided mounting module having circuit components disposed on both sides (main surfaces 90a and 90b) of the module substrate 90. In this case, some or all of the semiconductor components 61 to 65, for example, may be disposed on the main surface 90b of the module substrate 90.

### 1.4. Leakage Path of Transmission Signal in Radio Frequency Module 1

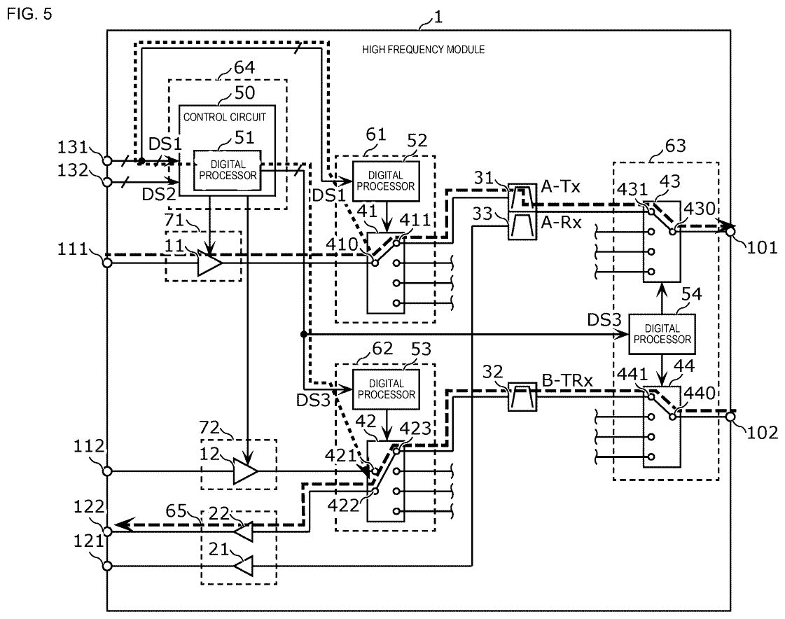

An example of a leakage path of a transmission signal in the radio frequency module 1 according to this embodiment will be described with reference to FIG. 5. FIG. 5 is a diagram showing an example of the leakage path of the transmission signal in the radio frequency module 1 according to this embodiment. In FIG. 5, dashed arrows represent signal paths, and dotted arrows represent leakage paths.

In FIG. 5, transmission of a signal of the band A and reception of a signal of the band B are performed simultaneously. In this event, the switch circuit 41 connects the common terminal 410 to the selection terminal 411, and the switch circuit 42 connects the terminal 422 to the terminal 423. Moreover, the switch circuit 43 connects the common terminal 430 to the selection terminal 431, and the switch circuit 44 connects the common terminal 440 to the selection terminal 441.

Accordingly, the transmission signal of the band A is transmitted from the radio frequency input terminal 111 to the antenna connection terminal 101 through the power amplifier 11, the switch circuit 41, the filter 31, and the switch circuit 43. The reception signal of the band B is transmitted from the antenna connection terminal 102 to the radio frequency output terminal 122 through the switch circuit 44, the filter 32, the switch circuit 42, and the low-noise amplifier 22.

In this case, a part of the transmission signal of the band A leaks into a reception path of the band B through the switch circuit 41, the digital processor 51, and the switch circuit 42. However, the digital processor 51 interposed in the leakage path reduces the leakage. In other words, isolation between the switch circuits 41 and 42 is improved when the switch circuit 41 is connected to the control terminal 131 without the digital processor 51 interposed therebetween, compared to when the switch circuit 41 is connected to the output end of the digital processor 51.

Particularly, when the band B is a TDD band, the switch circuit 42 includes the terminal 422 connected to the low-noise amplifier 22, making the transmission signal of the band A prone to leak into the reception path of the band B. Furthermore, when the harmonic wave band of the transmission band of the band A at least partially overlaps with the reception band of the band B, the leakage of the transmission signal of the band A into the reception path of the band B becomes a major factor in reducing receiving sensitivity of the signal of the band B. Under such conditions, a significant effect is achieved in suppressing the transmission signal of the band A from leaking into the reception path of the band B through the transmission line of the control signal.

### 1.5. Summary

As described above, the radio frequency module 1 according to this embodiment includes: the control terminal 131 for receiving the digital control signal DS1; the control circuit 50 connected to the control terminal 131; the power amplifiers 11 and 12 connected to the control circuit 50; the filter 31 having the pass band including the transmission band of the band A; the filter 32 having the pass band including the transmission band of the band B; the switch circuit 41 included in the semiconductor component 61 and connected between the power amplifier 11 and the filter 31; and the switch circuit 42 included in the semiconductor component 62 and connected between the power amplifier 12 and the filter 32. The control circuit 50 includes the digital processor 51 configured to process the digital control signal DS1. One of the switch circuits 41 and 42 is connected to the output end of the digital processor 51. The other of the switch circuits 41 and 42 is connected to the control terminal 131 without the digital processor 51 interposed therebetween.

With the above configuration, one of the switch circuits 41 and 42 is connected to the output end of the digital processor 51, and the other of the switch circuits 41 and 42 is connected to the control terminal 131 without the digital processor 51 interposed therebetween. Therefore, in order for a radio frequency signal to reach the switch circuit 42 from the switch circuit 41 through the transmission line of the control signal, the signal needs to pass through the digital processor 51. In other words, the digital processor 51 interferes with the connection between the switch circuits 41 and 42 through the transmission line of the control signal. This makes it possible to improve the isolation between the switch circuits 41 and 42. As a result, the transmission signal of the band A can be suppressed from leaking to the switch circuit 42 from the switch circuit 41 through the transmission line of the control signal. Accordingly, quality deterioration can be suppressed by reducing loss of the transmission signal of the band A.

For example, the radio frequency module 1 according to this embodiment may further include the control terminal 132 for receiving the digital control signal DS2. The control terminal 132 may be connected to the control circuit 50. The digital processor 51 may be configured to output the digital control signal DS3 by combining the digital control signal DS1 and the digital control signal DS2. The band A may be included in the first band group, and the band B may be included in the second band group or the third band group, the second band group and the third band group being higher than the first band group. The switch circuit 41 may be connected to the control terminal 131 without the digital processor 51 interposed therebetween, and the switch circuit 42 may be connected to the output end of the digital processor 51.

With the above configuration, the two digital control signals DS1 and DS2 can be combined into a single digital control signal DS3, thereby reducing the number of control lines and terminals in the radio frequency module 1. In such a case, deterioration of the transmission signal of the band A can also be suppressed by improving the isolation between the switch circuits 41 and 42.

For example, in the radio frequency module 1 according to this embodiment, the digital control signals DS1, DS2, and DS3 may each include a serial data signal.

Accordingly, serial data signals commonly used in a front-end device can be used to control the radio frequency module 1.

For example, the radio frequency module 1 according to this embodiment may further include: the digital processor 52 included in the semiconductor component 61, connected between the control terminal 131 and the switch circuit 41 without the digital processor 51 interposed therebetween, and configured to process the digital control signal DS1; and the digital processor 53 included in the semiconductor component 62, connected between the digital processor 51 and the switch circuit 42, and configured to process the digital control signal DS3.

With the above configuration, the digital processor 52 capable of processing the digital control signal DS1 is included in the same semiconductor component 61 as the switch circuit 41, and the digital processor 53 capable of processing the digital control signal DS3 is included in the same semiconductor component 62 as the switch circuit 42. Therefore, the number of components can be reduced, allowing for downsizing of the radio frequency module 1.

For example, the radio frequency module 1 according to this embodiment may further include: the switch circuit 43 connected between the filter 31 and the antenna connection terminal 101; and the switch circuit 44 connected between the filter 32 and the antenna connection terminal 102. The switch circuits 43 and 44 may be connected to the output end of the digital processor 51.

With the above configuration, the combined digital control signal DS3 can be used to control the switch circuits 43 and 44. Therefore, the number of control lines and terminals in the radio frequency module 1 can be reduced compared to the case where the digital control signals DS1 and DS2 are used directly to control the switch circuits 43 and 44.

For example, the radio frequency module 1 according to this embodiment may further include the digital processor 54 connected between the digital processor 51 and the switch circuits 43 and 44, and configured to process the digital control signal DS3. The digital processor 54 and the switch circuits 43 and 44 may be included in the semiconductor component 63. In the semiconductor component 63, the digital processor 54 may be disposed between the switch circuits 43 and 44.

With the above configuration, the digital processor 54 capable of processing the digital control signal DS3 is disposed between the switch circuits 43 and 44 in the semiconductor component 63. This makes it possible to improve the isolation between the switch circuits 43 and 44, and to suppress the transmission signal of the band A from leaking into the transmission path of the band B through the switch circuits 43 and 44.

For example, in the radio frequency module 1 according to this embodiment, the bands A and B may be a band combination capable of simultaneous communication.

Accordingly, upon simultaneous transmission of signals of the bands A and B, the transmission signal of one of the bands A and B can be suppressed from leaking to the transmission path of the other of the bands A and B through the transmission line of the control signal. This is effective in suppressing deterioration of the transmission signals of the bands A and B.

For example, the radio frequency module 1 according to this embodiment may further include the low-noise amplifier 22. The band B may be a TDD band. The switch circuit 42 may include the terminal 421 connected to the power amplifier 12, the terminal 422 connected to the low-noise amplifier 22, and the terminal 423 connected to the filter 32.

With the above configuration, upon simultaneous transmission and reception of the transmission signal of the band A and the reception signal of the band B, the transmission signal of the band A can be suppressed from leaking to the reception path of the band B through the transmission line of the control signal. This is effective in suppressing deterioration in receiving sensitivity of the band B. Particularly, since the band B is a TDD band and the low-noise amplifier 22 is connected to the switch circuit 42, improving the isolation between the switch circuits 41 and 42 is highly effective in suppressing deterioration in receiving sensitivity of the band B.

For example, in the radio frequency module 1 according to this embodiment, the harmonic wave band of the transmission band of the band A may at least partially overlap with the band B.

Accordingly, since the harmonic waves of the band A significantly affect the deterioration in receiving sensitivity of the band B, suppressing the transmission signal of the band A from leaking into the reception path of the band B through the transmission line of the control signal is highly effective in suppressing the deterioration in receiving sensitivity of the band B.

### Embodiment 2

Next, Embodiment 2 will be described. This embodiment differs from Embodiment 1 described above mainly in that the switch circuit 43, as with the switch circuit 41, is connected to the control terminal 131 without the digital processor 51 interposed therebetween. Such differences between this embodiment and Embodiment 1 will be mainly described below with reference to the drawings.

A communication device 5 according to this embodiment is the same as the communication device 5 according to Embodiment 1, except for including a radio frequency module 1A instead of the radio frequency module 1. Therefore, illustration and description of a configuration of the communication device 5 according to this embodiment will be omitted.

### 2.1. Circuit Configuration of Radio Frequency Module 1A

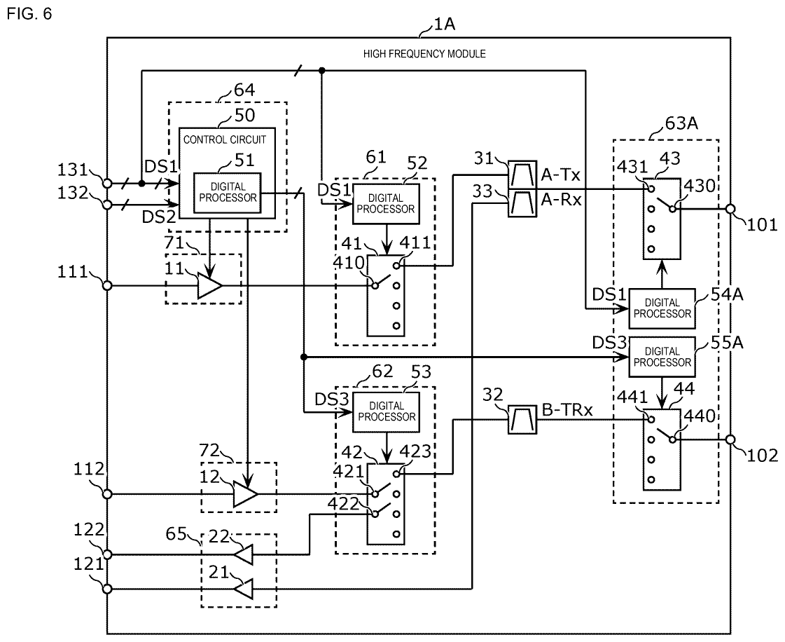

A circuit configuration of the radio frequency module 1A according to this embodiment will be described with reference to FIG. 6. FIG. 6 is a circuit configuration diagram of the radio frequency module 1A according to this embodiment.

Note that FIG. 6 shows an exemplary configuration, and the radio frequency module 1A can be implemented using any of a wide variety of circuit implementations and circuit technologies. Therefore, the following description of the radio frequency module 1A is not to be construed as limiting.

The radio frequency module 1A includes power amplifiers 11 and 12, low-noise amplifiers 21 and 22, filters 31, 32, and 33, switch circuits 41, 42, 43, and 44, a control circuit 50, digital processors 51, 52, 53, 54A, and 55A, antenna connection terminals 101 and 102, radio frequency input terminals 111 and 112, radio frequency output terminals 121 and 122, and control terminals 131 and 132.

The digital processor 54A is an example of a fourth digital processor, and is included in a semiconductor component 63A. The digital processor 54A is connected between the control terminal 131 and the switch circuit 43 without the digital processor 51 interposed therebetween. Specifically, the digital processor 54A has an input end connected to the control terminal 131 without the digital processor 51 interposed therebetween. The digital processor 54A has an output end connected to the switch circuit 43. The digital processor 54A can output a control signal for controlling the switch circuit 43 by processing a digital control signal DS1 supplied from the RFIC 3 through the control terminal 131.

The digital processor 55A is an example of a fifth digital processor, and is included in the semiconductor component 63A. The digital processor 55A is connected between the digital processor 51 and the switch circuit 44. Specifically, the digital processor 55A has an input end connected to an output end of the digital processor 51. The digital processor 55A has an output end connected to the switch circuit 44. The digital processor 55A can output a control signal for controlling the switch circuit 44 by processing a digital control signal DS3 supplied from the digital processor 51.

### 2.2. Mounting Example of Semiconductor Component 63A

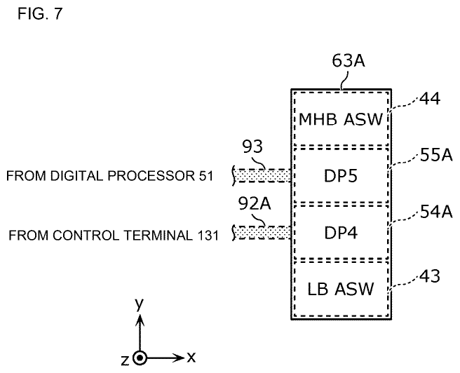

The radio frequency module 1A according to this embodiment differs from the radio frequency module 1 according to Embodiment 1 described above mainly in that the semiconductor component 63A and a control line 92A are provided instead of the semiconductor component 63 and the control line 92. Therefore, the semiconductor component 63A and the control line 92A will be described with reference to FIG. 7.

FIG. 7 is a layout diagram of the semiconductor component 63A and the control line 92A according to this embodiment. In FIG. 7, each component is labeled to facilitate understanding of positional relationships between the components. In FIG. 7, regions within the semiconductor component and part of wiring within the module substrate 90 are indicated by dashed lines.

Note that FIG. 7 illustrates an exemplary configuration, and the semiconductor component 63A and the control line 92A can be implemented using any of a wide variety of circuit implementations and circuit technologies. Therefore, the following description of the semiconductor component 63A and the control line 92A is not to be construed as limiting.

The semiconductor component 63A is an example of a third semiconductor component, and is disposed on the main surface 90a of the module substrate 90. The semiconductor component 63A includes the switch circuit 43 (LB ASW), the switch circuit 44 (MHB ASW), the digital processor 54A (DP4), and the digital processor 55A (DP5). In the semiconductor component 63A, the digital processors 54A and 55A are disposed between the switch circuits 43 and 44. The semiconductor component 63A is electrically connected to the semiconductor component 64 through the control line 93 formed on and/or in the module substrate 90. The semiconductor component 63A is also electrically connected to the control terminal 131 disposed on the main surface 90b of the module substrate 90 through the control line 92A formed on and/or in the module substrate 90.

### 2.3. Summary

As described above, the radio frequency module 1A according to this embodiment may further include: the switch circuit 43 connected between the filter 31 and the antenna connection terminal 101; and the switch circuit 44 connected between the filter 32 and the antenna connection terminal 102. The switch circuit 43 may be connected to the control terminal 131 without the digital processor 51 interposed therebetween, and the switch circuit 44 may be connected to the output end of the digital processor 51.

With the above configuration, the switch circuit 43 is connected to the control terminal 131 without the digital processor 51 interposed therebetween, and the switch circuit 44 is connected to the output end of the digital processor 51. Therefore, in order for a radio frequency signal to reach the switch circuit 44 from the switch circuit 43 through a transmission line of a control signal, the signal needs to pass through the digital processor 51. In other words, the digital processor 51 interferes with the connection between the switch circuits 43 and 44 through the transmission line of the control signal. This makes it possible to improve the isolation between the switch circuits 43 and 44. As a result, the transmission signal of the band A can be suppressed from leaking to the switch circuit 44 from the switch circuit 43 through the transmission line of the control signal. This makes it possible to suppress quality deterioration by reducing loss of the transmission signal of the band A.

For example, the radio frequency module 1A according to this embodiment may further include: the digital processor 54A connected between the control terminal 131 and the switch circuit 43 without the digital processor 51 interposed therebetween, and configured to process the digital control signal DS1; and the digital processor 55A connected between the digital processor 51 and the switch circuit 44 and configured to process the digital control signal DS3. The digital processors 54A and 55A and the switch circuits 43 and 44 may be included in the semiconductor component 63A. In the semiconductor component 63A, the digital processors 54A and 55A may be disposed between the switch circuits 43 and 44.

With the above configuration, the digital processors 54A and 55A are disposed between the switch circuits 43 and 44 in the semiconductor component 63A. This makes it possible to improve the isolation between the switch circuits 43 and 44, and to suppress the transmission signal of the band A from leaking into the transmission path of the band B through the switch circuits 43 and 44.

### Embodiment 3

Next, Embodiment 3 will be described. This embodiment differs from Embodiment 2 described above mainly in that a switch circuit 43 is included in the same semiconductor component as a switch circuit 41. Such differences between this embodiment and Embodiment 2 will be mainly described below with reference to the drawings.

A communication device 5 according to this embodiment is the same as the communication device 5 according to Embodiment 1, except for including a radio frequency module 1B instead of the radio frequency module 1. Therefore, illustration and description of a configuration of the communication device 5 according to this embodiment will be omitted.

### 3.1. Circuit Configuration of Radio Frequency Module 1B

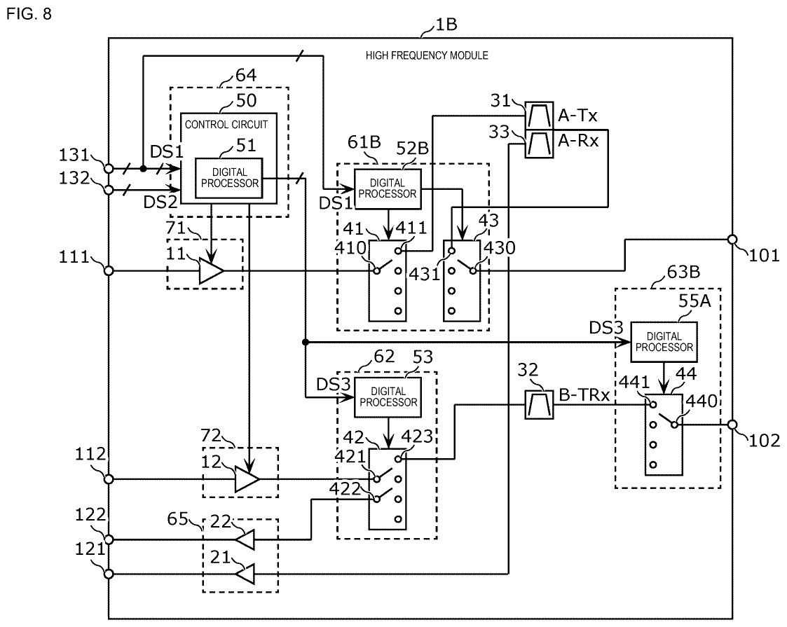

A circuit configuration of the radio frequency module 1B according to this embodiment will be described with reference to FIG. 8. FIG. 8 is a circuit configuration diagram of the radio frequency module 1B according to this embodiment.

Note that FIG. 8 shows an exemplary configuration, and the radio frequency module 1B can be implemented using any of a wide variety of circuit implementations and circuit technologies. Therefore, the following description of the radio frequency module 1B is not to be construed as limiting.

The radio frequency module 1B includes power amplifiers 11 and 12, low-noise amplifiers 21 and 22, filters 31, 32, and 33, switch circuits 41, 42, 43, and 44, a control circuit 50, digital processors 51, 52B, 53, and 55A, antenna connection terminals 101 and 102, radio frequency input terminals 111 and 112, radio frequency output terminals 121 and 122, and control terminals 131 and 132.

The switch circuit 43 is an example of a third switch circuit, and is included in the same semiconductor component 61B as the switch circuit 41.

The digital processor 52B is an example of a second digital processor, and is included in the semiconductor component 61B. The digital processor 52B is connected between the control terminal 131 and the switch circuits 41 and 43 without the digital processor 51 interposed therebetween. Specifically, the digital processor 52B has an input end connected to the control terminal 131 without the digital processor 51 interposed therebetween. The digital processor 52B has first and second output ends connected to the switch circuits 41 and 43, respectively. The digital processor 52B can output a control signal for controlling the switch circuits 41 and 43 by processing a digital control signal DS1 supplied from the RFIC 3 through the control terminal 131.

### 3.2. Mounting Example of Semiconductor Components 61B and 63B

The radio frequency module 1B according to this embodiment differs from the radio frequency modules 1 and 1A according to Embodiments 1 and 2 described above mainly in that semiconductor components 61B and 63B are provided instead of the semiconductor components 61 and 63. Therefore, the semiconductor components 61B and 63B will be described with reference to FIGS. 3 and 8.

The semiconductor component 61B is an example of a first semiconductor component, and is disposed on the main surface 90a of the module substrate 90, as with the semiconductor component 61. The semiconductor component 61B includes the switch circuits 41 and 43 and the digital processor 52B. The semiconductor component 61B is electrically connected to the control terminal 131 disposed on the main surface 90b of the module substrate 90 through the control line 92 formed on and/or in the module substrate 90.

The semiconductor component 63B is an example of a third semiconductor component, and is disposed on the main surface 90a of the module substrate 90, as with the semiconductor component 63. The semiconductor component 63B includes the switch circuit 44 and the digital processor 55A. The semiconductor component 63B is electrically connected to the semiconductor component 64 through the control line 93 formed on and/or in the module substrate 90.

### 3.3. Summary

As described above, in the radio frequency module 1B according to this embodiment, the switch circuit 43 may be included in the semiconductor component 61B.

With the above configuration, since the switch circuit 43 is included in the same semiconductor component 61B as the switch circuit 41, the number of control lines and terminals for transmitting the digital control signal DS1 to control the switch circuits 41 and 43 can be reduced.

### Embodiment 4

Next, Embodiment 4 will be described. This embodiment differs from Embodiment 1 described above mainly in that a digital control signal DS1 including a serial data signal is converted into a digital control signal DS2C including a parallel data signal. Such differences between this embodiment and Embodiment 1 will be mainly described below with reference to the drawings.

A communication device 5 according to this embodiment is the same as the communication device 5 according to Embodiment 1, except for including a radio frequency module 1C instead of the radio frequency module 1. Therefore, illustration and description of a configuration of the communication device 5 according to this embodiment will be omitted.

### 4.1. Circuit Configuration of Radio Frequency Module 1C

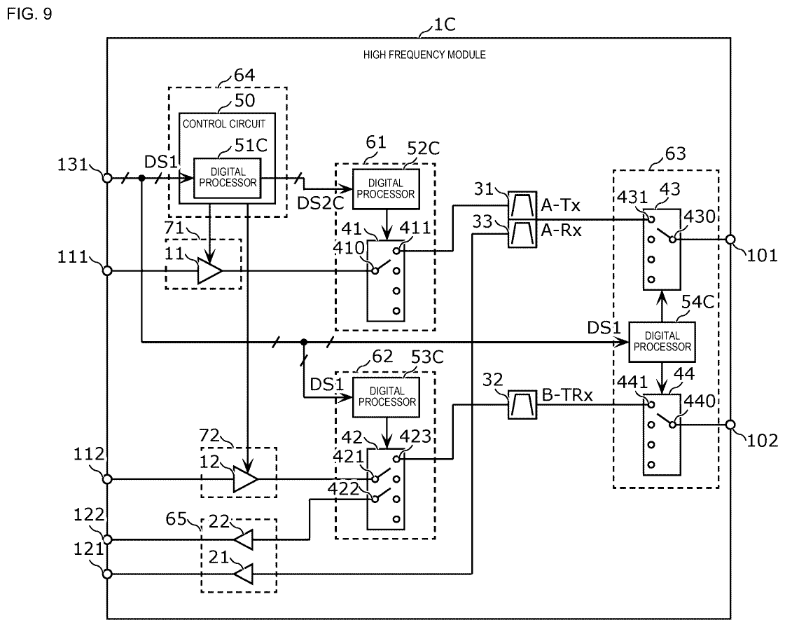

A circuit configuration of the radio frequency module 1C according to this embodiment will be described with reference to FIG. 9. FIG. 6 is a circuit configuration diagram of the radio frequency module 1C according to this embodiment.

Note that FIG. 6 shows an exemplary configuration, and the radio frequency module 1C can be implemented using any of a wide variety of circuit implementations and circuit technologies. Therefore, the following description of the radio frequency module 1C is not to be construed as limiting.

The radio frequency module 1C includes power amplifiers 11 and 12, low-noise amplifiers 21 and 22, filters 31, 32, and 33, switch circuits 41, 42, 43, and 44, a control circuit 50, digital processors 51C, 52C, 53C, and 54C, antenna connection terminals 101 and 102, radio frequency input terminals 111 and 112, radio frequency output terminals 121 and 122, and a control terminal 131.

The digital processor 51C is an example of a first digital processor, and is connected between the control terminal 131 and the digital processor 52C. Specifically, the digital processor 51C has an input end connected to the control terminal 131. The digital processor 51C has an output end connected to an input end of the digital processor 52C. The digital processor 51C can process the digital control signal DS1 supplied from the RFIC 3 through the control terminal 131. Specifically, the digital processor 51C can convert the digital control signal DS1 into the digital control signal DS2C.

The digital processor 52C is an example of a second digital processor, and is included in a semiconductor component 61. The digital processor 52C is connected between the digital processor 51C and the switch circuit 41. Specifically, the digital processor 52C has an input end connected to the output end of the digital processor 51C. The digital processor 52C has an output end connected to the switch circuit 41. The digital processor 52C can output a control signal for controlling the switch circuit 41 by processing the digital control signal DS2C supplied from the digital processor 51C.

The digital processor 53C is an example of a third digital processor, and is included in a semiconductor component 62. The digital processor 53C is connected between the control terminal 131 and the switch circuit 42 without the digital processor 51C interposed therebetween. Specifically, the digital processor 53C has an input end connected to the control terminal 131 without the digital processor 51C interposed therebetween. The digital processor 53C has an output end connected to the switch circuit 42. The digital processor 53C can output a control signal for controlling the switch circuit 42 by processing the digital control signal DS1 supplied from the RFIC 3 through the control terminal 131.

The digital processor 54C is an example of a fourth digital processor, and is included in a semiconductor component 63. The digital processor 54C is connected between the control terminal 131 and the switch circuits 43 and 44 without the digital processor 51C interposed therebetween. Specifically, the digital processor 54C has an input end connected to the control terminal 131 without the digital processor 51C interposed therebetween. The digital processor 54C has first and second output ends connected to the switch circuits 43 and 44, respectively. The digital processor 54C can output a control signal for controlling the switch circuits 43 and 44 by processing the digital control signal DS1 supplied from the RFIC 3 through the control terminal 131. Note that, as with the digital processor 54, the digital processor 54C may be disposed between the switch circuits 43 and 44 in the semiconductor component 63.

The digital control signal DS1 is an example of a first digital control signal, and is a control signal for the first band group, the second band group, and the third band group. The digital control signal DS1 includes a serial data signal. The serial data signal refers to a data signal used in serial communication, and refers to a signal for sequentially transmitting data one bit at a time on a transmission line. The digital control signal DS1 may include a source-synchronous serial data signal or a clock-embedded serial data signal.

The digital control signal DS2C is an example of a second digital control signal, and is a control signal for the first band group. The digital control signal DS2C includes a parallel data signal. The parallel data signal refers to a data signal used in parallel communication, and refers to a plurality of signals for simultaneously transmitting a plurality of bits of data on a plurality of transmission lines. A general purpose input/output (GPIO), for example, can be used to transmit and receive the parallel data signal.

### 4.2. Summary

As described above, in the radio frequency module 1C according to this embodiment, the digital processor 51C may be configured to convert the digital control signal DS1 into the digital control signal DS2C. The digital control signal DS1 may include a serial data signal, and the digital control signal DS2C may include a parallel data signal. The band A may be included in the first band group, and the band B may be included in the second band group or the third band group, the second band group and the third band group being higher than the first band group. The switch circuit 41 may be connected to the output end of the digital processor 51C. The switch circuit 42 may be connected to the control terminal 131 without the digital processor 51C interposed therebetween.

With the above configuration, the serial data signal can be converted into the parallel data signal, making it possible to suppress leakage of the transmission signal of the band A from the switch circuit 41 to the switch circuit 42 through the transmission line of the control signal. As a result, quality deterioration can be suppressed by reducing loss of the transmission signal of the band A.

For example, the radio frequency module 1C according to this embodiment may further include: the digital processor 52C included in the semiconductor component 61, connected between the digital processor 51C and the switch circuit 41, and configured to process the digital control signal DS2C; and the digital processor 53C included in the semiconductor component 62, connected between the control terminal 131 and the switch circuit 42 without the digital processor 51C interposed therebetween, and configured to process the digital control signal DS1.

With the above configuration, the digital processor 52C capable of processing the digital control signal DS2C is included in the same semiconductor component 61 as the switch circuit 41, and the digital processor 53C capable of processing the digital control signal DS1 is included in the same semiconductor component 62 as the switch circuit 42. Therefore, the number of components can be reduced, allowing for downsizing of the radio frequency module 1C.

For example, the radio frequency module 1C according to this embodiment may further include: the switch circuit 43 connected between the filter 31 and the antenna connection terminal 101; and the switch circuit 44 connected between the filter 32 and the antenna connection terminal 102. The switch circuits 43 and 44 may be connected to the control terminal 131 without the digital processor 51C interposed therebetween.

With the above configuration, the digital control signal DS1 can be used to control the switch circuits 43 and 44. Therefore, the number of control lines and terminals in the radio frequency module 1C can be reduced compared to the case where the digital control signal DS3 is used to control the switch circuits 43 and 44.

For example, the radio frequency module 1C according to this embodiment may further include the digital processor 54C connected between the control terminal 131 and the switch circuits 43 and 44 without the digital processor 51C interposed therebetween, and configured to process the digital control signal DS1. The digital processor 54C and the switch circuits 43 and 44 may be included in the semiconductor component 63. In the semiconductor component 63, the digital processor 54C may be disposed between the switch circuits 43 and 44.

With the above configuration, the digital processor 54C capable of processing the digital control signal DS1 is disposed between the switch circuits 43 and 44 in the semiconductor component 63. This makes it possible to improve the isolation between the switch circuits 43 and 44, and to suppress the transmission signal of the band A from leaking into the transmission path of the band B through the switch circuits 43 and 44.

### Embodiment 5

Next, Embodiment 5 will be described. This embodiment differs from Embodiment 1 described above mainly in that switch circuits 41 and 43 are isolated by a digital processor. Such differences between this embodiment and Embodiment 1 will be mainly described below with reference to the drawings.

A communication device 5 according to this embodiment is the same as the communication device 5 according to Embodiment 1, except for including a radio frequency module 1D instead of the radio frequency module 1. Therefore, illustration and description of a configuration of the communication device 5 according to this embodiment will be omitted.

### 5.1. Circuit Configuration of Radio Frequency Module 1D

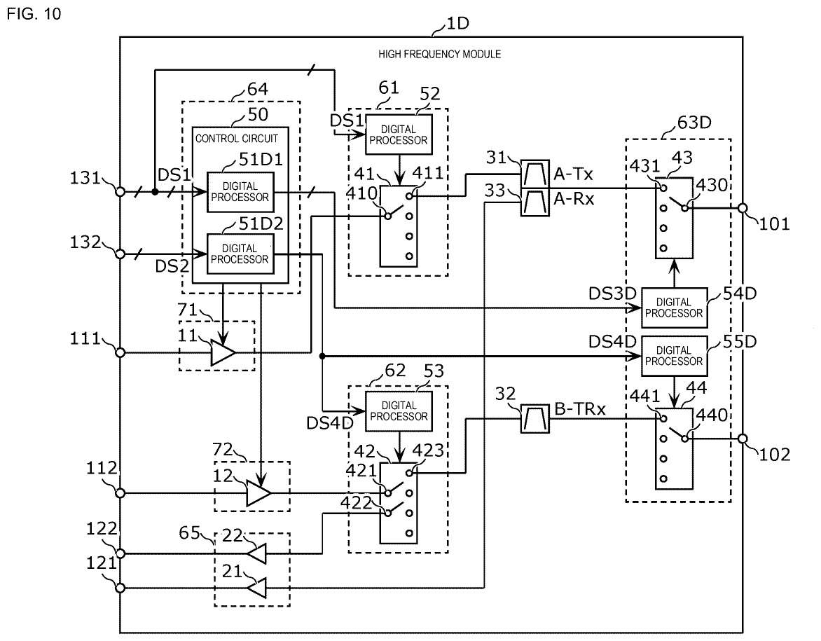

A circuit configuration of the radio frequency module 1D according to this embodiment will be described with reference to FIG. 10. FIG. 10 is a circuit configuration diagram of the radio frequency module 1D according to this embodiment.

Note that FIG. 10 shows an exemplary configuration, and the radio frequency module 1D can be implemented using any of a wide variety of circuit implementations and circuit technologies. Therefore, the following description of the radio frequency module 1D is not to be construed as limiting.

The radio frequency module 1D includes power amplifiers 11 and 12, low-noise amplifiers 21 and 22, filters 31, 32, and 33, switch circuits 41, 42, 43, and 44, a control circuit 50, digital processors 51D1, 51D2, 52, 53, 54D, and 55D, antenna connection terminals 101 and 102, radio frequency input terminals 111 and 112, radio frequency output terminals 121 and 122, and control terminals 131 and 132.

The digital processor 51D1 is an example of a first digital processor, and is connected between the control terminal 131 and the digital processor 54D. Specifically, the digital processor 51D1 has an input end connected to the control terminal 131. The digital processor 51D1 has an output end connected to an input end of the digital processor 54D. The digital processor 51D1 can process a digital control signal DS1 supplied from the RFIC 3 through the control terminal 131. Specifically, the digital processor 51D1 can convert the digital control signal DS1 into a digital control signal DS3D.

The digital processor 51D2 is an example of a second digital processor, and is connected between the control terminal 132 and the digital processors 53 and 55D. Specifically, the digital processor 51D2 has an input end connected to the control terminal 131. The digital processor 51D2 has an output end connected to input ends of the digital processors 53 and 55D. The digital processor 51D2 can process a digital control signal DS2 supplied from the RFIC 3 through the control terminal 132. Specifically, the digital processor 51D2 can convert the digital control signal DS2 into a digital control signal DS4D.

The digital processor 52 is included in a semiconductor component 61. The digital processor 52 is connected between the control terminal 131 and the switch circuit 41 without the digital processor 51D1 interposed therebetween. Specifically, the digital processor 52 has an input end connected to the control terminal 131 without the digital processor 51D1 interposed therebetween. The digital processor 52 has an output end connected to the switch circuit 41. The digital processor 52 can output a control signal for controlling the switch circuit 41 by processing the digital control signal DS1 supplied from the RFIC 3 through the control terminal 131.

The digital processor 53 is included in a semiconductor component 62. The digital processor 53 is connected between the digital processor 51D2 and the switch circuit 42. Specifically, the digital processor 53 has the input end connected to the output end of the digital processor 51D2. The digital processor 53 has an output end connected to the switch circuit 42. The digital processor 53 can output a control signal for controlling the switch circuit 42 by processing the digital control signal DS4D supplied from the digital processor 51D2.

The digital processor 54D is included in a semiconductor component 63D. The digital processor 54D is connected between the digital processor 51D1 and the switch circuit 43. Specifically, the digital processor 54D has the input end connected to the output end of the digital processor 51D1. The digital processor 54D has an output end connected to the switch circuit 43. The digital processor 54D can output a control signal for controlling the switch circuit 43 by processing the digital control signal DS3D supplied from the digital processor 51D1. As with the digital processor 54A, the digital processor 54D may be disposed between the switch circuits 43 and 44 in the semiconductor component 63D.

The digital processor 54D may be connected between the control terminal 131 and the switch circuit 43 without the digital processor 51D1 interposed therebetween. In other words, the switch circuit 43 may be connected to the control terminal 131 through the digital processor 54D, not through the digital processor 51D1. In this case, the digital processor 52 may be connected between the digital processor 51D1 and the switch circuit 41. That is, the switch circuit 41 may be connected to the output end of the digital processor 51D1 through the digital processor 52. In this embodiment, the switch circuit 43 serves as an example of the downstream switching circuitry.

The digital processor 55D is included in a semiconductor component 63D. The digital processor 55D is connected between the digital processor 51D2 and the switch circuit 44. Specifically, the digital processor 55D has the input end connected to the output end of the digital processor 51D2. The digital processor 55D has an output end connected to the switch circuit 44. The digital processor 55D can output a control signal for controlling the switch circuit 44 by processing the digital control signal DS4D supplied from the digital processor 51D2. Note that, as with the digital processor 55A, the digital processor 55D may be disposed between the switch circuits 43 and 44 in the semiconductor component 63D.

The digital control signal DS1 is an example of a first digital control signal, and is a control signal for the first band group in this embodiment. The digital control signal DS2 is an example of a second digital control signal, and is a control signal for the second band group and the third band group in this embodiment. The digital control signal DS3D is a control signal including a parallel data signal for the first band group. The digital control signal DS4D is a control signal including a parallel data signal for the second band group and the third band group.

### 5.2. Leakage Path of Transmission Signal in Radio Frequency Module 1D

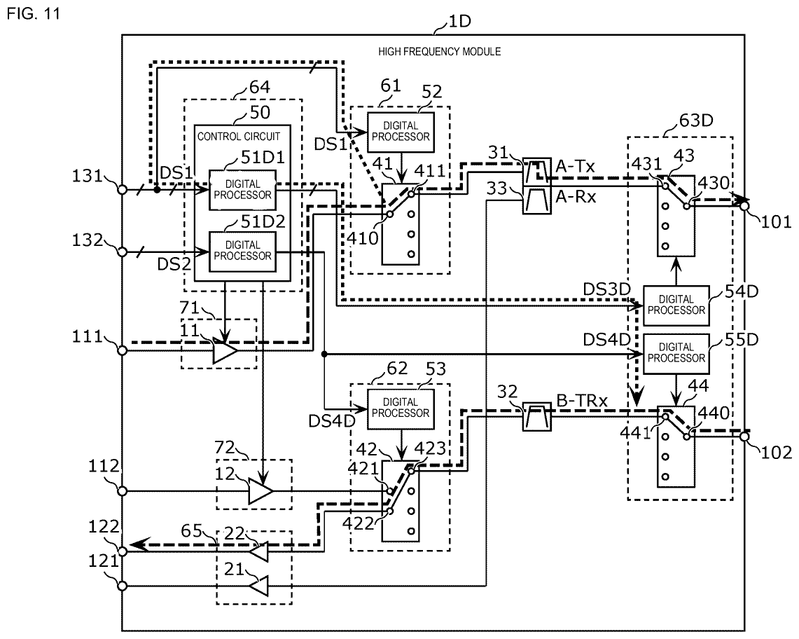

An example of a leakage path of a transmission signal in the radio frequency module 1D according to this embodiment will be described with reference to FIG. 11. FIG. 11 is a diagram showing an example of the leakage path of the transmission signal in the radio frequency module 1D according to this embodiment. In FIG. 11, dashed arrows represent signal paths, and dotted arrows represent leakage paths.

In FIG. 11, transmission of a signal of the band A and reception of a signal of the band B are performed simultaneously. In this event, the switch circuit 41 connects the common terminal 410 to the selection terminal 411, and the switch circuit 42 connects the terminal 422 to the terminal 423. Moreover, the switch circuit 43 connects the common terminal 430 to the selection terminal 431, and the switch circuit 44 connects the common terminal 440 to the selection terminal 441.

Accordingly, the transmission signal of the band A is transmitted from the radio frequency input terminal 111 to the antenna connection terminal 101 through the power amplifier 11, the switch circuit 41, the filter 31, and the switch circuit 43. The reception signal of the band B is transmitted from the antenna connection terminal 102 to the radio frequency output terminal 122 through the switch circuit 44, the filter 32, the switch circuit 42, and the low-noise amplifier 22.

In this case, a part of the transmission signal of the band A leaks into a reception path of the band B through the switch circuit 41, the digital processor 51D1, and the switch circuit 44. However, the digital processor 51D1 interposed in the leakage path reduces the leakage. In other words, isolation between the switch circuits 41 and 44 is improved when the switch circuit 41 is connected to the control terminal 131 without the digital processor 51D1 interposed therebetween, compared to when the switch circuit 41 is connected to the output end of the digital processor 51D1.

Particularly, when the harmonic wave band of the transmission band of the band A at least partially overlaps with the reception band of the band B, the leakage of the transmission signal of the band A into the reception path of the band B becomes a major factor in reducing receiving sensitivity of the signal of the band B. Under such conditions, a significant effect is achieved in suppressing the transmission signal of the band A from leaking into the reception path of the band B through the transmission line of the control signal.

### 5.3. Summary

As described above, the radio frequency module 1D according to this embodiment includes: the control terminal 131 for receiving the digital control signal DS1; the control circuit 50 connected to the control terminal 131; the power amplifiers 11 and 12 connected to the control circuit 50; the filter 31 having a pass band including the transmission band of the band A; the filter 32 having a pass band including the transmission band of the band B; the switch circuit 41 included in the semiconductor component 61 and connected between the power amplifier 11 and the filter 31; the switch circuit 42 included in the semiconductor component 62 and connected between the power amplifier 12 and the filter 32; the switch circuit 43 included in the semiconductor component 63D and connected between the filter 31 and the antenna connection terminal 101; and the switch circuit 44 included in the semiconductor component 63D and connected between the filter 32 and the antenna connection terminal 102. The control circuit 50 includes the digital processor 51D1 configured to process the digital control signal DS1. One of the switch circuits 41 and 43 is connected to the output end of the digital processor 51D1, and the other of the switch circuits 41 and 43 is connected to the control terminal 131 without the digital processor 51D1 interposed therebetween.

Accordingly, one of the switch circuits 41 and 43 is connected to the output end of the digital processor 51D1, and the other of the switch circuits 41 and 43 is connected to the control terminal 131 without the digital processor 51D1 interposed therebetween. Therefore, in order for a radio frequency signal to reach the switch circuit 43 from the switch circuit 41 through the transmission line of the control signal, the signal needs to pass through the digital processor 51D1. In other words, the digital processor 51D1 interferes with the connection between the switch circuits 41 and 43 through the transmission line of the control signal. This makes it possible to improve the isolation between the switch circuits 41 and 43. As a result, the transmission signal of the band A can be suppressed from leaking to the switch circuit 44 and the like from the switch circuit 41 through the transmission line of the control signal and the switch circuit 43. This makes it possible to suppress quality deterioration by reducing loss of the transmission signal of the band A.

For example, the radio frequency module 1D according to this embodiment may further include the control terminal 132 for receiving the digital control signal DS2. The switch circuit 42 may be connected to the control terminal 132.

With the above configuration, the switch circuit 42 is connected to the control terminal 132 different from that connected to the switch circuit 41. This makes it possible to improve the isolation between the switch circuits 41 and 42. As a result, the transmission signal of the band A can be suppressed from leaking to the switch circuit 42 from the switch circuit 41 through the transmission line of the control signal. Accordingly, quality deterioration can be suppressed by reducing loss of the transmission signal of the band A.

For example, in the radio frequency module 1D according to this embodiment, the control terminal 132 may be connected to the control circuit 50. The control circuit 50 may further include the digital processor 51D2 configured to process the digital control signal DS2. The switch circuit 42 may be connected to the control terminal 132 through the digital processor 51D2.

With the above configuration, the switch circuit 42 can be controlled based on the signal processed by the digital processor 51D2.

### Embodiment 6

Next, Embodiment 6 will be described. This embodiment differs from Embodiment 5 described above mainly in that a switch circuit 43 is included in the same semiconductor component as the switch circuit 41, and a coupler and its associated switch circuit are included in the same semiconductor component as a switch circuit 44. Such differences between this embodiment and Embodiment 5 will be mainly described below with reference to the drawings.

A communication device 5 according to this embodiment is the same as the communication device 5 according to Embodiment 1, except for including a radio frequency module 1E instead of the radio frequency module 1. Therefore, illustration and description of a configuration of the communication device 5 according to this embodiment will be omitted.

### 6.1. Circuit Configuration of Radio Frequency Module 1E

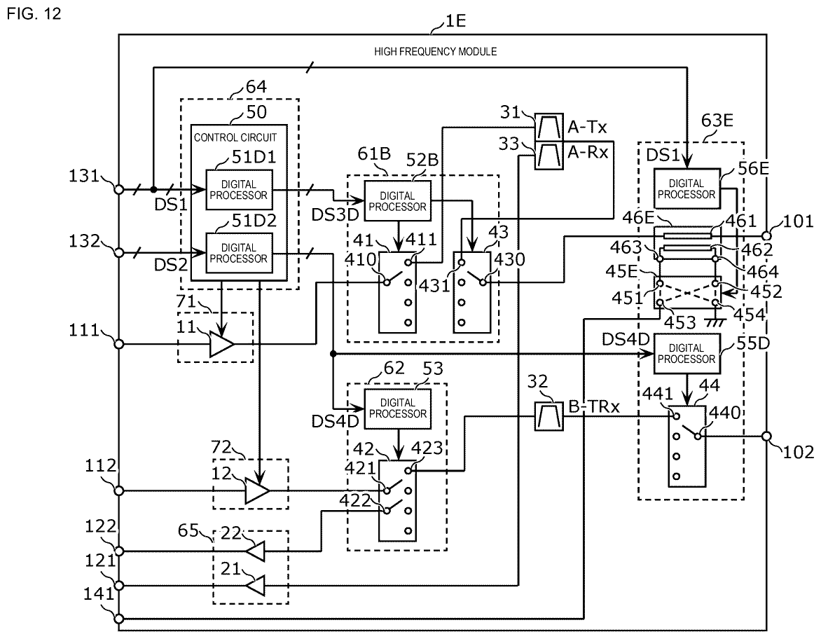

A circuit configuration of the radio frequency module 1E according to this embodiment will be described with reference to FIG. 12. FIG. 12 is a circuit configuration diagram of the radio frequency module 1E according to this embodiment.

Note that FIG. 12 shows an exemplary configuration, and the radio frequency module 1E can be implemented using any of a wide variety of circuit implementations and circuit technologies. Therefore, the following description of the radio frequency module 1E is not to be construed as limiting.

The radio frequency module 1E includes power amplifiers 11 and 12, low-noise amplifiers 21 and 22, filters 31, 32, and 33, switch circuits 41, 42, 43, 44, and 45E, a coupler 46E, a control circuit 50, digital processors 51D1, 51D2, 52B, 53, 55D, and 56E, antenna connection terminals 101 and 102, radio frequency input terminals 111 and 112, radio frequency output terminals 121 and 122, control terminals 131 and 132, and a feedback terminal 141.

The feedback terminal 141 is an external connection terminal of the radio frequency module 1E. The feedback terminal 141 is connected to the RFIC 3 outside the radio frequency module 1E. The feedback terminal 141 is also connected to the switch circuit 45E inside the radio frequency module 1E. This allows the radio frequency module 1E to feed back a part of a radio frequency signal transmitted between the antenna connection terminal 101 and the switch circuit 43 to the RFIC 3 through the feedback terminal 141.

In this embodiment, as in Embodiment 3, the switch circuit 43 is included in the same semiconductor component 61B as the switch circuit 41.

The coupler 46E is a bidirectional coupler, and is included in a semiconductor component 63E. The coupler 46E includes a main line 461, a sub-line 462, a forward coupling port 463, and a reverse coupling port 464.

The main line 461 is connected between the antenna connection terminal 101 and the switch circuit 43. Specifically, the main line 461 has one end connected to the antenna connection terminal 101. The main line 461 has the other end connected to the common terminal 430 of the switch circuit 43.

The sub-line 462 can be coupled to the main line 461, and is connected between the forward coupling port 463 and the reverse coupling port 464. Specifically, the sub-line 462 has one end connected to the forward coupling port 463. The sub-line 462 has the other end connected to the reverse coupling port 464.

The forward coupling port 463 is a terminal for outputting a part of the radio frequency signal transmitted from the switch circuit 43 to the antenna connection terminal 101. The forward coupling port 463 is connected to the switch circuit 45E.

The reverse coupling port 464 is a terminal for outputting a part of the radio frequency signal transmitted from the antenna connection terminal 101 to the switch circuit 43. The reverse coupling port 464 is connected to the switch circuit 45E.

The switch circuit 45E is an example of a fifth switch circuit, and is included in the same semiconductor component 63E as the switch circuit 44. The switch circuit 45E can switch between the forward output and the reverse output of the coupler 46E. Specifically, the switch circuit 45E includes terminals 451, 452, 453, and 454. The terminal 451 is connected to the forward coupling port 463 of the coupler 46E. The terminal 452 is connected to the reverse coupling port 464 of the coupler 46E. The terminal 453 is connected to the feedback terminal 141. The terminal 454 is terminated. This switch circuit 45E connects the terminal 451 to the terminal 453 and connects the terminal 452 to the terminal 454 in the forward output of the coupler 46E. In the reverse output of the coupler 46E, on the other hand, the switch circuit 45E connects the terminal 451 to the terminal 454 and connects the terminal 452 to the terminal 453.

The digital processor 56E is included in the semiconductor component 63E, and is connected between the control terminal 131 and the switch circuit 45E without the digital processor 51D1 interposed therebetween. Specifically, the digital processor 56E has an input end connected to the control terminal 131 without the digital processor 51D1 interposed therebetween. The digital processor 56E has an output end connected to the switch circuit 45E. The digital processor 56E can output a control signal for controlling the switch circuit 45E by processing the digital control signal DS1 supplied from the RFIC 3 through the control terminal 131. In this embodiment, the switch circuitry 45E serves as an example of the downstream switching circuitry. In the radio frequency module 1E as described above, when transmission of a signal of the band A and reception of a signal of the band B are performed simultaneously, the digital processor 51D1 suppresses leakage of the signal of the band A into the reception path of the band B from the switch circuit 41.

### 6.2. Summary

As described above, the radio frequency module 1E according to this embodiment includes: the control terminal 131 for receiving the digital control signal DS1; the control circuit 50 connected to the control terminal 131; the power amplifiers 11 and 12 connected to the control circuit 50; the filter 31 having a pass band including the transmission band of the band A; the filter 32 having a pass band including the transmission band of the band B; the switch circuit 41 included in the semiconductor component 61B and connected between the power amplifier 11 and the filter 31; the switch circuit 42 included in the semiconductor component 62 and connected between the power amplifier 12 and the filter 32; the switch circuit 43 included in the semiconductor component 61B and connected between the filter 31 and the antenna connection terminal 101; the switch circuit 44 included in the semiconductor component 63E and connected between the filter 32 and the antenna connection terminal 102; the coupler 46E included in the semiconductor component 63E and connected between the switch circuit 43 and the antenna connection terminal 101; and the switch circuit 45E configured to switch between the forward output and the reverse output of the coupler 46E. The control circuit 50 includes the digital processor 51D1 configured to process the digital control signal DS1. One of the switch circuits 41 and 45E is connected to the output end of the digital processor 51D1. The other of the switch circuits 41 and 45E is connected to the control terminal 131 without the digital processor 51D1 interposed therebetween.

With the above configuration, one of the switch circuits 41 and 45E is connected to the output end of the digital processor 51D1, and the other of the switch circuits 41 and 45E is connected to the control terminal 131 without the digital processor 51D1 interposed therebetween. Therefore, in order for a radio frequency signal to reach the switch circuit 45E from the switch circuit 41 through the transmission line of the control signal, the signal needs to pass through the digital processor 51D1. In other words, the digital processor 51D1 interferes with the connection between the switch circuits 41 and 45E through the transmission line of the control signal. This makes it possible to improve the isolation between the switch circuits 41 and 45E. As a result, the transmission signal of the band A can be suppressed from leaking to the switch circuit 44 and the like from the switch circuit 41 through the transmission line of the control signal and the switch circuit 45E. Accordingly, quality deterioration can be suppressed by reducing loss of the transmission signal of the band A.

For example, the radio frequency module 1E according to this embodiment may further include the control terminal 132 for receiving the digital control signal DS2. The switch circuit 42 may be connected to the control terminal 132.

With the above configuration, the switch circuit 42 is connected to the control terminal 132 different from that connected to the switch circuit 41. This makes it possible to improve the isolation between the switch circuits 41 and 42. As a result, the transmission signal of the band A can be suppressed from leaking to the switch circuit 42 from the switch circuit 41 through the transmission line of the control signal. Accordingly, quality deterioration can be suppressed by reducing loss of the transmission signal of the band A.

For example, in the radio frequency module 1E according to this embodiment, the control terminal 132 may be connected to the control circuit 50. The control circuit 50 may further include the digital processor 51D2 configured to process the digital control signal DS2. The switch circuit 42 may be connected to the control terminal 132 through the digital processor 51D2.

With the above configuration, the switch circuit 42 can be controlled based on the signal processed by the digital processor 51D2.

### Other Embodiments

Although the radio frequency modules according to the present disclosure have been described above based on the embodiments, the radio frequency module according to the present disclosure is not limited to the above embodiments. Other embodiments realized by combining any of the components in the above embodiments, modifications obtained by making various changes to the above embodiments, which can be conceived by those skilled in the art without departing from the spirit of the present disclosure, and various devices incorporating any of the radio frequency modules described above are also included in the present disclosure.

For example, in the circuit configuration of the radio frequency module according to each of the above embodiments, other circuit elements, wiring, and the like may be inserted between the paths connecting the circuit elements and signal paths disclosed in the drawings. For example, an impedance matching circuit may be connected between the power amplifier 11 and the switch circuit 41 and/or between the power amplifier 12 and the switch circuit 42. Moreover, for example, an impedance matching circuit may be inserted between the filters 31 and 33 and the switch circuit 43 and/or between the filter 32 and the switch circuit 44. Furthermore, for example, a coupler may be connected between the switch circuit 43 and the antenna connection terminal 101 and/or between the switch circuit 44 and the antenna connection terminal 102.

The present disclosure can be widely used as a radio frequency module disposed in a front-end part of a communication device such as a mobile phone.

What is claimed is:

1. A radio frequency module comprising:
a first control terminal configured to receive a first digital control signal;
a control circuit connected to the first control terminal;
a first power amplifier and a second power amplifier, each connected to the control circuit;
a first filter having a pass band including a transmission band of a first band;
a second filter having a pass band including a transmission band of a second band;
a first switch circuit included in a first semiconductor component and connected between the first power amplifier and the first filter; and
a second switch circuit included in a second semiconductor component and connected between the second power amplifier and the second filter, wherein
the control circuit includes a first digital processor configured to process the first digital control signal,
a first one of the first switch circuit and the second switch circuit is connected to an output end of the first digital processor, and
a second one of the first switch circuit and the second switch circuit is connected to the first control terminal without the first digital processor interposed therebetween.

2. The radio frequency module according to claim 1, further comprising:
a second control terminal configured to receive a second digital control signal, wherein
the second control terminal is connected to the control circuit,
the first digital processor is configured to output a third digital control signal by combining the first digital control signal and the second digital control signal,
the first band is included in a first band group,
the second band is included in a second band group or a third band group, the second band group and the third band group being higher than the first band group,
the first switch circuit is connected to the first control terminal without the first digital processor interposed therebetween, and
the second switch circuit is connected to the output end of the first digital processor.

3. The radio frequency module according to claim 2, wherein
the first digital control signal, the second digital control signal, and the third digital control signal each include a serial data signal.

4. The radio frequency module according to claim 2, further comprising:
a second digital processor included in the first semiconductor component, connected between the first control terminal and the first switch circuit without the first digital processor interposed therebetween, and configured to process the first digital control signal; and
a third digital processor included in the second semiconductor component, connected between the first digital processor and the second switch circuit, and configured to process the third digital control signal.

5. The radio frequency module according to claim 2, further comprising:
a third switch circuit connected between the first filter and a first antenna connection terminal; and
a fourth switch circuit connected between the second filter and a second antenna connection terminal, wherein
the third switch circuit and the fourth switch circuit are connected to the output end of the first digital processor.

6. The radio frequency module according to claim 5, further comprising:
a fourth digital processor connected between the first digital processor and both the third switch circuit and the fourth switch circuit, and configured to process the third digital control signal, wherein
the fourth digital processor, the third switch circuit, and the fourth switch circuit are included in a third semiconductor component, and
the fourth digital processor is disposed between the third switch circuit and the fourth switch circuit in the third semiconductor component.

7. The radio frequency module according to claim 2, further comprising:
a third switch circuit connected between the first filter and a first antenna connection terminal; and
a fourth switch circuit connected between the second filter and a second antenna connection terminal, wherein
the third switch circuit is connected to the first control terminal without the first digital processor interposed therebetween, and
the fourth switch circuit is connected to the output end of the first digital processor.

8. The radio frequency module according to claim 7, further comprising:
a fourth digital processor connected between the first control terminal and the third switch circuit without the first digital processor interposed therebetween, and configured to process the first digital control signal; and
a fifth digital processor connected between the first digital processor and the fourth switch circuit, and configured to process the third digital control signal, wherein
the fourth digital processor, the fifth digital processor, the third switch circuit, and the fourth switch circuit are included in a third semiconductor component, and
the fourth digital processor and the fifth digital processor are disposed between the third switch circuit and the fourth switch circuit in the third semiconductor component.

9. The radio frequency module according to claim 7, wherein
the third switch circuit is included in the first semiconductor component.

10. The radio frequency module according to claim 1, wherein
the first digital processor is configured to convert the first digital control signal into a second digital control signal,
the first digital control signal includes a serial data signal,
the second digital control signal includes a parallel data signal,
the first band is included in a first band group,
the second band is included in a second band group or a third band group, the second band group and the third band group being higher than the first band group,
the first switch circuit is connected to the output end of the first digital processor, and
the second switch circuit is connected to the first control terminal without the first digital processor interposed therebetween.

11. The radio frequency module according to claim 10, further comprising:
a second digital processor included in the first semiconductor component, connected between the first digital processor and the first switch circuit, and configured to process the second digital control signal; and
a third digital processor included in the second semiconductor component, connected between the first control terminal and the second switch circuit without the first digital processor interposed therebetween, and configured to process the first digital control signal.

12. The radio frequency module according to claim 10, further comprising:
a third switch circuit connected between the first filter and a first antenna connection terminal; and
a fourth switch circuit connected between the second filter and a second antenna connection terminal, wherein
the third switch circuit and the fourth switch circuit are connected to the first control terminal without the first digital processor interposed therebetween.

13. The radio frequency module according to claim 12, further comprising:
a fourth digital processor connected between the first control terminal and both the third switch circuit and the fourth switch circuit without the first digital processor interposed therebetween, and configured to process the first digital control signal, wherein
the fourth digital processor, the third switch circuit, and the fourth switch circuit are included in a third semiconductor component, and
the fourth digital processor is disposed between the third switch circuit and the fourth switch circuit in the third semiconductor component.

14. The radio frequency module according to claim 1, wherein
the first band and the second band are a band combination capable of simultaneous communication.

15. The radio frequency module according to claim 14, further comprising:
a low-noise amplifier, wherein
the second band is a TDD band, and
the second switch circuit includes a first terminal connected to the second power amplifier, a second terminal connected to the low-noise amplifier, and a third terminal connected to the second filter.

16. The radio frequency module according to claim 15, wherein
a harmonic wave band of a transmission band of the first band at least partially overlaps with the second band.

17. A radio frequency module comprising:
a first control terminal configured to receive a first digital control signal;
a control circuit connected to the first control terminal and including a first digital processor;
a first power amplifier and a second power amplifier;
a first filter and
a second filter;
a first switch circuit included in a first semiconductor component and connected between the first power amplifier and the first filter;
a second switch circuit included in a second semiconductor component and connected between the second power amplifier and the second filter;
downstream switch circuitry, wherein
the first digital processor is configured to process the first digital control signal,
a first one of the first switch circuit and the downstream switch circuitry is connected to an output end of the first digital processor, and
a second one of the first switch circuit and the downstream switch circuitry is connected to the first control terminal without the first digital processor interposed therebetween.

18. The radio frequency module according to claim 17, wherein the downstream switching circuitry is a third switch circuit included in a third semiconductor component and connected between the first filter and a first antenna connection terminal.

19. The radio frequency module according to claim 17, wherein the downstream switching circuitry is
a fifth switch circuit configured to switch between a forward output and a reverse output of the coupler.

20. The radio frequency module according to claim 17, further comprising:
a second control terminal for receiving a second digital control signal, wherein
the second switch circuit is connected to the second control terminal.
